(19) United States
(12) Patent Application Publication
(10) Pub. No.: US 2026/0112117 A1
(43) Pub. Date: Apr. 23, 2026

(54) VIDEO GENERATION METHOD AND APPARATUS, ELECTRONIC DEVICE, AND STORAGE MEDIUM

(71) Applicant: Beijing Zitiao Network Technology Co., Ltd., Haidian District, Beijing (CN)

(72) Inventors: Jichang YANG, Beijing (CN); Jingfu CHEN, Beijing (CN); Xiaofeng LI, Beijing (CN); Qi DONG, Beijing (CN); Zehua BAO, Beijing (CN)

(21) Appl. No.: 19/117,003

(22) PCT Filed: Sep. 15, 2023
(86) PCT No.: PCT/CN2023/119036

§ 371 Date: Mar. 28, 2025

(30) Foreign Application Priority Data
Sep. 28, 2022 (CN) 202211194243.4

(51) Int. Cl. G06T 17/20; G06T 7/70; G06T 13/20

(52) U.S. Cl. CPC G06T 17/20; G06T 7/70; G06T 13/20

(57) ABSTRACT

Embodiments of the present disclosure provide a video generation method and apparatus, an electronic device, and a storage medium. The method includes: determining current scenario identifying information for a target object; and determining a target animation video for the target object according to the scenario identifying information and an animation image corresponding to the target object, where the animation image includes displaying position information of at least a portion of mesh models of a target model corresponding to the target object being displayed in preset video frames, and the target animation video includes the preset video frames.

This application claims priority to Chinese Patent Application No. 202211194243.4, filed with the China National Intellectual Property Administration on Sep. 28, 2022, which is incorporated herein by reference in its entirety.

### FIELD

Embodiments of the present disclosure relate to the technology of image processing, and in particular, relate to a video generation method and apparatus, an electronic device, and a storage medium.

### BACKGROUND

With the continuous development of image processing technology, integrated video processing functions in related application software are also constantly enriching. For example, animation data of a corresponding target object can be played based on a terminal device.

A main processing method adopted is to store a model structure corresponding to the target object in each frame of animation data. When the number of frames corresponding to the animation data is large, a plurality of model structures needs to be stored, leading to the problem of a large data storage amount. Accordingly, when rendering the animation data, the plurality of model structures needs to be retrieved, resulting in a technical problem about the inability to render in real-time when the performance of the terminal device is poor.

### SUMMARY

The present disclosure provides a video generation method and apparatus, an electronic device, and a storage medium, thereby achieving the effects that a data storage amount is reduced, and different target animation videos can be rapidly and simultaneously rendered in the same displaying interface.

In a first aspect, an embodiment of the present disclosure provides a video generation method. The method includes:
determining current scenario identifying information for a target object; and
determining a target animation video for the target object according to the scenario identifying information and an animation image corresponding to the target object,
where the animation image includes displaying position information of at least a portion of mesh models of a target model corresponding to the target object being displayed in preset video frames, and the target animation video includes the preset video frames.

In a second aspect, an embodiment of the present disclosure further provides a video generation apparatus. The apparatus includes:
a scenario identifying information determination module, configured to determine current scenario identifying information for a target object; and
a target animation video determination module, configured to determine a target animation video for the target object according to the scenario identifying information and an animation image corresponding to the target object,
where the animation image includes displaying position information of at least a portion of mesh models of a target model corresponding to the target object being displayed in preset video frames, and the target animation video includes the preset video frames.

In a third aspect, an embodiment of the present disclosure further provides an electronic device. The electronic device includes:
one or more processors; and
a storage apparatus, configured to store one or more programs,
where the one or more programs, when executed by the one or more processors, cause the one or more processors to implement the video generation method according to any one of the embodiments of the present disclosure.

In a fourth aspect, an embodiment of the present disclosure further provides a storage medium including computer-executable instructions. The computer-executable instructions, when executed by a computer processor, are used to perform the video generation method according to any one of the embodiments of the present disclosure.

### BRIEF DESCRIPTION OF THE DRAWINGS

Throughout the accompanying drawings, the same or similar reference numerals denote the same or similar elements. It should be understood that the accompanying drawings are illustrative, and components and elements may not necessarily be drawn to scale.

FIG. 1 is a schematic flowchart of a method for creating an animation image according to an embodiment of the present disclosure;

FIG. 2 is a schematic flowchart of a video generation method according to an embodiment of the present disclosure;

FIG. 3 is a schematic flowchart of another video generation method according to an embodiment of the present disclosure;

FIG. 4 is a schematic flowchart of another video generation method according to an embodiment of the present disclosure;

FIG. 5 is a schematic flowchart of another video generation method according to an embodiment of the present disclosure;

FIG. 6 is a schematic diagram of a structure of a video generation apparatus according to an embodiment of the present disclosure; and

FIG. 7 is a schematic diagram of a structure of an electronic device according to an embodiment of the present disclosure.

### DETAILED DESCRIPTION OF EMBODIMENTS

Embodiments of the present disclosure will be described with reference to the accompanying drawings below. Although the accompanying drawings show some embodiments of the present disclosure, it should be understood that the present disclosure may be implemented in various forms, and should not be construed as being limited to the embodiments stated herein. These embodiments are provided for a more thorough and complete understanding of the present disclosure. It should be understood that the accompanying drawings and the embodiments of the present disclosure are for exemplary purposes only, and are not intended to limit the scope of protection of the present disclosure.

A plurality of steps recorded in method implementations of the present disclosure may be performed in different orders and/or in parallel. In addition, additional steps may be included and/or the execution of the illustrated steps may be omitted in the method implementations. The scope of the present disclosure is not limited in this aspect.

The term “including” used herein and variations thereof are open-ended inclusions, namely “including but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. Related definitions of other terms will be given in the description below.

Terms such as “first” and “second” used in the present disclosure are only for distinguishing different apparatuses, modules, or units, and are not intended to limit the order or relation of interdependence of functions performed by these apparatuses, modules, or units.

The terms “one” and “a plurality of” used in the present disclosure are illustrative and not restrictive, and those skilled in the art would understand that these terms should be understood as “one or more”, unless the context explicitly specifies otherwise.

The names of messages or information exchanged between a plurality of apparatuses in the implementations of the present disclosure are used for illustrative purposes only, and are not used to limit the scopes of these messages or information.

Before the use of the technical solutions disclosed in the plurality of embodiments of the present disclosure, a user shall be informed of the type, range of use, application scenarios, etc., of personal information involved in the present disclosure in an appropriate manner in accordance with relevant laws and regulations, and the authorization of the user shall be obtained.

For example, in response to receiving an active request from the user, a prompt message is sent to the user to clearly inform the user that a requested operation will require access to and use of the personal information of the user. As such, the user can independently choose, based on the prompt message, whether to provide the personal information to software or hardware, such as an electronic device, an application, a server, or a storage medium, that performs the operations of the technical solutions of the present disclosure.

As an optional but non-limiting implementation, in response to receiving the active request from the user, the method for sending the prompt message to the user may be, for example, a pop-up window, in which the prompt message may be presented in text. Further, the pop-up window may also carry a selection control for the user to choose whether to “agree” or “disagree” to provide the personal information to the electronic device.

The above notification and user authorization obtaining process is only illustrative, which does not limit the implementations of the present disclosure, and other methods that comply with the relevant laws and regulations may also be applied to the implementations of the present disclosure.

Data (including the data itself, and data acquisition, or usage) involved in the technical solutions should comply with the requirements of the corresponding laws and regulations, and relevant stipulations.

Before introducing the present technical solution, application scenarios are first exemplarily described. The technical solution of the embodiment of the present disclosure may be applied to a scenario of playing an animation video of a target object in any displaying frame. Exemplarily, the displaying frame may include a plurality of target objects. When a target animation video corresponding to any of the target objects needs to be played, animation images containing a plurality of preset animation segments may be prestored. The plurality of preset animation segments corresponds to animation images with different row number ranges, such that when an effect prop is triggered, scenario identifying information to which the target object currently belongs is determined. Then, a corresponding row number range corresponding to the scenario identifying information is determined within the animation image corresponding to the target object, such that a target animation video corresponding to the target object is determined based on the row number range. Pixel values of a plurality of pixel points in the animation image may represent displaying positions of a plurality of model vertices in a target model corresponding to the target object in a preset video frame, thereby simultaneously rendering target animation videos corresponding to the plurality of target objects on the premise of reducing the data storage amount, and allowing a displaying interface including the plurality of target objects to present a clustered animation effect.

A corresponding effect prop may be integrated based on the method provided in this embodiment of the present disclosure, and therefore a corresponding effect video is generated based on a trigger operation for the effect prop. The method provided in this embodiment of the present disclosure may also be used as an effect package within the effect prop so as to generate, based on the effect package, a target animation video corresponding to the target object within a collected video frame after triggering the effect prop and adding the target object to the displaying interface, thereby achieving the effect that the effect video may include the animation video corresponding to the corresponding object so as to improve content richness of the displaying frame.

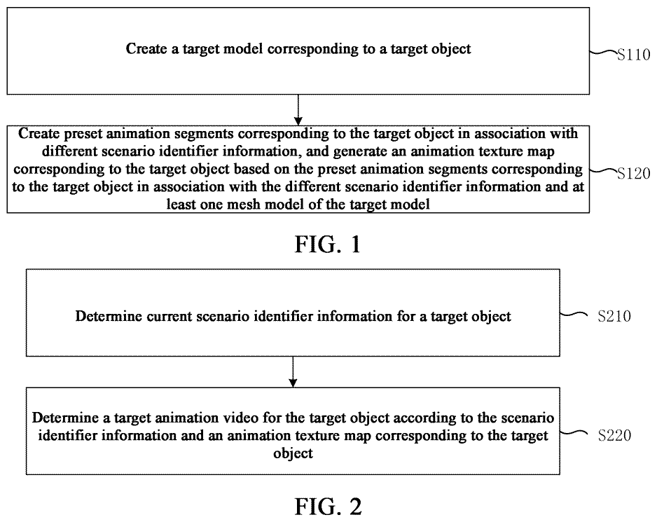

FIG. 1 is a schematic flowchart of an animation image creating method according to an embodiment of the present disclosure. This embodiment of the present disclosure is applicable to a case of storing preset animation segments corresponding to a target object in association with different scenario identifying information to a same animation image.

As shown in FIG. 1, the method includes:
S110: Create a target model corresponding to a target object.

In this embodiment, the target object may be any object displayed in a displaying interface, or any object added to the displaying interface by a user, or an object that requires creation of a corresponding model. For example, the target object may be an animated character or a pet, or the like. The target model may be a 3-dimensional (3D) model created based on the target object. The target model is composed of at least one mesh model, and each mesh model may be composed of at least three vertices, which may be used as model vertices.

When the target object is detected, the number of model vertices of the target model corresponding to the target object may be determined based on overall information of the target object. Then, limb information, torso information, and head information of the target object are determined to respectively construct a plurality of mesh models based on this information. Each mesh model may be composed of at least three model vertices. Each mesh model is filled with pixel information corresponding to the target object, and at least one mesh model is concatenated to form the target model corresponding to the target object.
S120: Create preset animation segments corresponding to the target object in association with different scenario identifying information, and generate an animation image corresponding to the target object based on the preset animation segments corresponding to the target object in the different scenario identifying information and the at least one mesh model of the target model.

In this embodiment, the scenario identifying information may be information for recognizing the position of the scenario. The scenario identifying information may represent an area range to which any scenario belongs. The scenario may be an occasion or environment where the target object performs corresponding actions. Exemplarily, the scenario may include a football field, a track, a stand, a gymnasium, or the like. The scenario identifying information may be a scenario name, a scenario picture, or a preset character string composed of numbers, letters, or symbols. Exemplarily, when the scenario is the football field, the scenario identifying information corresponding to the scenario may be “football field” text information, or a football field picture, or a preset custom character string corresponding to the football field.

The preset animation segment is composed of a plurality of video frames, and the plurality of video frames are used as preset video frames. Playback durations of preset animation segments corresponding to different scenario identifying information may vary, that is, the different scenario identifying information may correspond to preset animation segments with different numbers of video frames. The preset animation segment may be preset any animation. Optionally, the preset animation segments may include a standby animation segment, a walking animation segment, a running animation segment, a jump-in-place animation segment, and a dodge animation segment. The user may set the specific content of the preset animation segment according to actual needs.

Action information included in the preset animation segment may be corresponding action information after the target object completes one action. For example, action information included in the running animation segment may be a corresponding action when the target object takes one step during running; and action information included in the walking animation segment may be a corresponding action when the target object takes one step during walking.

In this embodiment, the animation image may be a texture image used to represent displaying position information of the plurality of model vertices in the preset video frame in the target model. The texture image includes a plurality of pixel points. A pixel value of each pixel point is used to represent a pixel value corresponding to the corresponding model vertex in the corresponding preset video frame, to determine a displaying position of the model vertex in the corresponding preset video frame based on the pixel value.

The animation image includes displaying position information of at least a portion of mesh models of the target model corresponding to the target object in the preset video frame. If the resolution of a video display is limited or the performance of a terminal device is not high, it may not be possible for model vertices of all mesh models to be detected by the user, and in this case, the animation image may be generated only by processing a portion of mesh models.

Next, content information of the animation image is described: each column of the animation image represents a model vertex, each row represents a preset video frame within a preset animation segment, and a pixel value of each pixel point in the animation image represents a displaying position of the model vertex in the corresponding preset video frame.

In this embodiment, the columns of the animation image may be used to represent the plurality of model vertices of the target model; and the rows of the animation image may be used to represent the plurality of preset video frames of the preset animation segments. The animation image may include a plurality of preset animation segments, and the arrangement of the plurality of preset animation segments may be based on user-defined settings, which is not specifically limited in this embodiment of the present disclosure. In a practical application process, the pixel value of each pixel point in the animation image may be used to represent the displaying position of the model vertex in the corresponding preset video frame. The displaying position of the model vertex in the preset video frame may be spatial position information of the model vertex in the preset video frame. Exemplarily, if the total number of model vertices in a target model is 100 and the number of preset video frames in a plurality of preset animation segments is 20, a finally generated animation image has 100 columns and 20 rows. The settings are advantageous as the model structures of the target model in all the preset video frames of the plurality of preset animation segments may be correspondingly stored in different rows in the same animation image, such that when determining a row number range, the pixel values within the corresponding row number range can be rapidly read so as to render the target object based on the pixel values, thereby obtaining a target animation video corresponding to the target object.

In practical applications, the action information corresponding to the target object in association with different scenario identifying information may be determined, and a preset animation segment corresponding to the target object in the scenario identifying information is created based on the action information corresponding to the target object in each scenario identifying information. Exemplarily, when the scenario identifying information for the target object is identifying information corresponding to a track, the action information corresponding to the identifying information for the track may include walking, running, or the like. In this case, the preset animation segment created based on the action information may be the walking animation segment, the running animation segment, or the like. After obtaining the target model and the plurality of preset animation segments, the animation image corresponding to the target object can be generated. Next, the process of creating the animation image is described.

Optionally, the step of generating an animation image corresponding to the target object based on the preset animation segments and at least one mesh model of the target model includes: acquiring, for each of the preset animation segments, a first preset video frame in a current preset animation segment, determining spatial position information of each of at least three model vertices on each mesh model in the first preset video frame, and determining pixel values of nth-row pixel points in the animation image based on the spatial position information; and acquiring a next preset video frame for the first preset video frame and repeatedly performing, until all preset video frames in the preset animation segment are traversed, the operation of determining pixel values corresponding to spatial position information of each of at least three model vertices on each mesh model, and updating an (n+1)th-row of the animation image with the determined pixel values.

The method for determining the pixel values corresponding to the spatial position information of the at least three model vertices on each mesh model in each preset video frame of the preset animation segment is the same. Therefore, one preset animation segment is used as an example for explanation.

Different target objects may have the same or different model structures. For example, if the body shapes of different target objects differ significantly, target model structures corresponding to the different target objects are different to a certain degree, and in this case, an animation image corresponding to each target object may be created. If the body shapes of all the target objects are consistent, one animation image may be created based on the plurality of preset animation segments, and the animation image is bound to the plurality of target objects, or the plurality of target objects invoke the same animation image. However, for the plurality of target objects, the method for determining animation images corresponding to the plurality of target objects is the same. Therefore, when the animation image is introduced, there is no need to distinguish whether target models of the different target objects are the same.

Herein, n corresponds to a frame number of the first preset video frame in the preset animation segments. Exemplarily, for the first preset video frame of the first preset animation segment, n may be 1; and for a next preset animation segment for the first preset animation segment, when the frame number of the first preset animation segment is 20, n corresponding to a first preset video frame of the next preset animation segment may be 21.

In practical applications, for each preset animation segment, the first preset video frame may be determined based on a timestamp displayed on each preset video frame in the current preset animation segment. Then, the model structure of the target model in the first video frame is determined, and the spatial position information of the at least three model vertices on each mesh model is determined based on the model structure. Further, the corresponding pixel values are determined according to the spatial position information, and the nth-row of the animation image corresponding to the first preset video frame of the current preset animation segment is filled with the determined plurality of pixel values, thereby obtaining the animation image including the nth-row pixel values. The settings are advantageous as the model structures of the target model in all the preset video frames of the plurality of preset animation segments may be stored in the same animation image, thereby achieving the effect of reducing the data storage amount.

Optionally, the step of determining pixel values of nth-row pixel points in the animation image based on the spatial position information includes: determining pixel values corresponding to spatial position information of at least three model vertices on each mesh model; and assigning the pixel values corresponding to the spatial position information of the at least three model vertices on each mesh model to a plurality of pixel points in the nth row based on model vertices corresponding to each column in the preset animation image.

In practical applications, after obtaining the spatial position information of at least three model vertices on each mesh model, a value range of the spatial position information of each model vertex of the target model and a value range of the pixel values in the animation image may be determined, and then, the spatial position information of each model vertex is converted into the corresponding pixel value through a linear mapping method, thereby obtaining the pixel value corresponding to the spatial position information of each model vertex. Then, the plurality of pixel points in the nth row may be determined according to the model vertices corresponding to each column in the animation image, and the pixel points corresponding to each model vertex are filled with the pixel values corresponding to the spatial position information of each model vertex, thereby obtaining the animation image including the nth-row pixel values. The settings are advantageous as reduced as the data storage amount is reduced, and the spatial position information of each model vertex may be converted into the pixel value to be correspondingly filled into the pixel point of the animation image, thereby rapidly generating the target animation video based on the animation image.

The next preset video frame for the first preset video frame is determined based on the timestamps displayed on the plurality of preset video frames in the current preset animation segment. The spatial position information of the at least three model vertices on each mesh model is determined based on the model structure of the target model in the next preset video frame. The spatial position information is converted into the pixel value through the linear mapping method. The pixel values are updated to the (n+1)th row in the vertex animation image until all the preset video frames in the current preset animation segment are completely traversed, thereby obtaining the animation image including the pixel values of each model vertex of the target model in all the preset video frames of the current preset animation segment.

In practical applications, after all the preset animation segments are completely traversed, the animation image corresponding to the target object can be obtained.

According to the technical solution of this embodiment of the present disclosure, by creating the target model corresponding to the target object, creating the preset animation segments corresponding to the target object in the different scenario identifying information, and generating the animation image corresponding to the target object according to the preset animation segments corresponding to the target object in the different scenario identifying information and at least one mesh model of the target model, the effect that the model structures corresponding to the plurality of video frames are stored in the same animation image so as to reduce the data storage amount is achieved, thereby improving the response speed of the terminal device when rendering the target animation video.

The different scenario identifying information correspond to different preset animation segments, the different preset animation segments correspond to different row number ranges in the animation image, and therefore in order to improve the efficiency of generating the target animation video corresponding to the target object, a correspondence between the scenario identifying information and the row number range in the animation image may be established, thereby rapidly generating the target animation video corresponding to the target object after determining the scenario identifying information corresponding to the target object.

Based on the above technical solution, the method further includes: establishing, according to a row number range corresponding to each preset animation segment in the animation image, a mapping relationship between the scenario identifying information and the row number range so as to determine the target animation video for the target object based on the mapping relationship.

In this embodiment, an arrangement sequence of the plurality of preset animation segments in the animation image may be preset in an animation image generation stage, and therefore the row number range corresponding to each preset animation segment in the animation image is determined based on the arrangement sequence of the plurality of preset animation segments and all preset video frames included in the plurality of preset animation segments. Exemplarily, if the preset animation segments include the standby animation segment, the walking animation segment, and the running animation segment. The number of all preset video frames included in the standby animation segment is 20, the number of all preset video frames included in the walking animation segment is 30, and the number of all preset video frames included in the running animation segment is 40. Additionally, the arrangement sequence of the plurality of preset animation segments in the animation image is: 1—the standby animation segment, 2—the walking animation segment, and 3—the running animation segment, the row number range corresponding to the standby animation segment in the animation image is from the row 1 to the row 20, the row number range corresponding to the walking animation segment in the animation image is from the row 21 to the row 50, and the row number range corresponding to the running animation segment in the animation image is from the row 51 to the row 90.

In practical applications, after determining the row number range corresponding to each preset animation segment in the animation image, the scenario identifying information and the row number range corresponding to the preset animation segment corresponding to the scenario identifying information may be associated based on the predetermined correspondence between each preset animation segment and the scenario identifying information, thereby establishing the mapping relationship between the scenario identifying information and the row number range corresponding to the scenario identifying information. Therefore, when determining the scenario identifying information for the target object, the row number range corresponding to the scenario identifying information in the animation image may be determined based on the mapping relationship, thereby generating the target animation video corresponding to the target object based on the corresponding row number range. The settings are advantageous as the association relationship between the scenario identifying information and the corresponding row number range in the animation image is established, and therefore when determining the current scenario identifying information for the target object, the pixel values within the corresponding row number range can be rapidly read, thereby rapidly generating the target animation video corresponding to the target object.

FIG. 2 is a schematic flowchart of a video generation method according to an embodiment of the present disclosure. This embodiment of the present disclosure is applicable to a case of determining, based on a pre-constructed animation image and current scenario identifying information for a target object, a target animation video corresponding to the target object. The method may be performed by a video generation apparatus, which may be implemented in the form of software and/or hardware, and is optionally implemented through an electronic device. The electronic device may be a mobile terminal, a personal computer (PC), a server, or the like.

The apparatus for performing the effect video generation method provided in this embodiment of the present disclosure may be integrated into application software supporting an effect video processing function. The software may be installed in an electronic device, and optionally, may be a mobile terminal, a PC, or the like. The application software may be a type of software for image/video processing. Specific application software is not enumerated, as long as image/video processing can be achieved. The apparatus for performing the effect video generation method provided in this embodiment of the present disclosure may also be software with a specifically developed application to achieve the addition and display of effects, or may be integrated into a corresponding page, and the user can process effect video through the integrated page in the PC.

As shown in FIG. 2, the method includes:
S210: Determine current scenario identifying information for a target object.

There may be one or more target objects, and the scenario identifying information corresponding to the plurality of target objects may be the same or different. Exemplarily, when the scenario is a sports field and includes a plurality of target objects, the scenario identifying information may include scenario identifying information corresponding to a track, scenario identifying information corresponding to a football field, scenario identifying information corresponding to a stand, etc.

In practical applications, when determining scenario identifying information corresponding to each target object, a current position of each target object may be first read, and therefore the scenario identifying information corresponding to each target object may be determined based on the current position of each target object.

Optionally, the step of determining current scenario identifying information for a target object includes: determining current position information of the target object; and determining, according to the current position information and preset spatial range information corresponding to a plurality of sub-scenarios, a target sub-scenario corresponding to the current position information and scenario identifying information corresponding to the target sub-scenario.

In this embodiment, the current position information of each target object may be information used to represent the position of the target object. The spatial range information of the sub-scenario may be preset information used to reflect a space distribution area of the sub-scenario. Optionally, the spatial range information may be represented by spatial range coordinates.

In the practical application process, a plurality of sub-scenarios may be pre-determined, and range coordinates of each sub-scenario are set to obtain the spatial range information corresponding to each sub-scenario. When detecting each target object, the current position information of each target object may be determined based on a displaying position of each target object in a displaying interface, and the current position information of each target object is compared with the spatial range information corresponding to the plurality of sub-scenarios. When detecting that the current position information of any target object is within the spatial range information of one of the plurality of sub-scenarios, the sub-scenario may be used as the target sub-scenario for the current position information of the target object, and based on the preset scenario identifying information corresponding to each sub-scenario, the scenario identifying information for the target sub-scenario is further determined. The settings are advantageous as the current scenario identifying information for the target object is rapidly determined, and then, a row number range in an animation image may be determined based on the scenario identifying information so as to generate a target animation video corresponding to the target object.
S220: Determine the target animation video for the target object according to the scenario identifying information and the animation image corresponding to the target object.

The animation image includes displaying position information of at least a portion of mesh models of a target model corresponding to the target object being displayed in preset video frames, and the target animation video includes the preset video frames.

In this embodiment, after determining the current scenario identifying information for the target object, the animation image corresponding to each target object may be acquired, and based on a mapping relationship between the scenario identifying information and the row number range within the animation image, the row number range corresponding to the scenario identifying information for the target object is determined in the animation image corresponding to each target object. Based on the row number range corresponding to the scenario identifying information for each target object, the preset video frame corresponding to the target object and the displaying position information of each mesh model of the target model of the target object in the preset video frame may be determined, thereby rendering, based on the displaying position information, the target animation video corresponding to the target object. The target animation video may be a video used to represent an animation displaying effect of the target object in the scenario identifying information. Exemplarily, when the current scenario identifying information for the target object is scenario identifying information corresponding to a track, the finally generated target animation video may be an animation video that the target object is running.

When determining the target animation video corresponding to the target object, to make a rendering effect of the target animation video closer to an expected effect of the preset animation segment, parameter information corresponding to the target animation video may also be determined, to determine the target animation video corresponding to the target object in combination with the parameter information.

Optionally, the step of determining the target animation video for the target object according to the scenario identifying information and the animation image corresponding to the target object includes: determining the target animation video according to the scenario identifying information, the animation image corresponding to at least one target object, and video parameters corresponding to the target animation video.

In this embodiment, the video parameters may be variables used to represent feature information of the target animation video, or may also be understood as parameters such as a playback frame number or resolution when the target animation video is played. The video parameters may be custom parameters set by the user in an application development stage. Optionally, the video parameters may include a target frame number of the target animation video.

Since different target objects correspond to different target animation videos, video parameters of the different target animation videos may vary as well, that is, the different target animation videos may respectively correspond to different video parameters.

In practical applications, after determining the current scenario identifying information for the target object and determining the row number range corresponding to the scenario identifying information in the animation image, the video parameters of the target animation video may also be acquired, such that the target animation video corresponding to the target object is determined based on the row number range corresponding to the current scenario identifying information for each target object and the video parameters corresponding to the target animation video for the target object. The settings are advantageous as the target animation video may be closer to the corresponding preset animation segment, thereby improving a displaying effect of the target animation video.

The target animation video may only include preset video frames, or may include other animation video frames besides the preset video frames. Since the rows in the animation image may be used to represent the preset video frames, whether all the animation video frames included in the target animation video are composed of the preset video frames may be decided by the video parameters of the target animation video and the row number range within the animation image.

To ensure a playback effect of the target animation video, after determining the target animation video corresponding to the target object, the target animation video corresponding to the target object may also be played, and in order to render a clustered animation effect on a displaying frame, different target animation videos may be played based on different playback methods.

Based on this and the above technical solution, the method further includes: playing a target animation video for each target object based on video playback parameters corresponding to the target animation video for each target object.

In this embodiment, the video playback parameters may be parameters used to represent a playback status of the target animation video, or may also be understood as parameters such as a playback duration or a playback method when playing the target animation video. The video playback parameters may be custom parameters set by the user in an application development stage. Optionally, the video playback parameters may include at least one of loop playback, single playback, a playback duration, and a next preset animation segment for the target animation video.

In practical applications, when each target animation video is played, the preset video playback parameters corresponding to each target animation video may be first acquired, and then the corresponding target animation video may be played based on the video playback parameters corresponding to each target animation video. Exemplarily, when the video playback parameters corresponding to the running animation video include the loop playback and the video playback parameters corresponding to the standby animation video include the single playback, a running animation video may be looped in the displaying interface, while the standby animation video may be played once. The settings are advantageous as the clustered animation effect may be rendered in the displaying interface, thereby improving the displaying effect of the target animation video in the displaying interface.

According to the technical solution of this embodiment of the present disclosure, by determining the current scenario identifying information for the at least one target object and determining the target animation video for the at least one target object according to the scenario identifying information and the animation image corresponding to the at least one target object, the problem that when the target animation video is rendered under the condition of the limited performance of the terminal device, the corresponding target animation video cannot be rendered is solved. The effect of rapidly generating the target animation video corresponding to each target object is achieved on the premise of reducing the data storage amount. Moreover, by making the target animation video correspond to the scenario identifying information, different target animation videos may be simultaneously rendered in the same displaying interface, thereby achieving the clustered animation effect and improving use experience of the user.

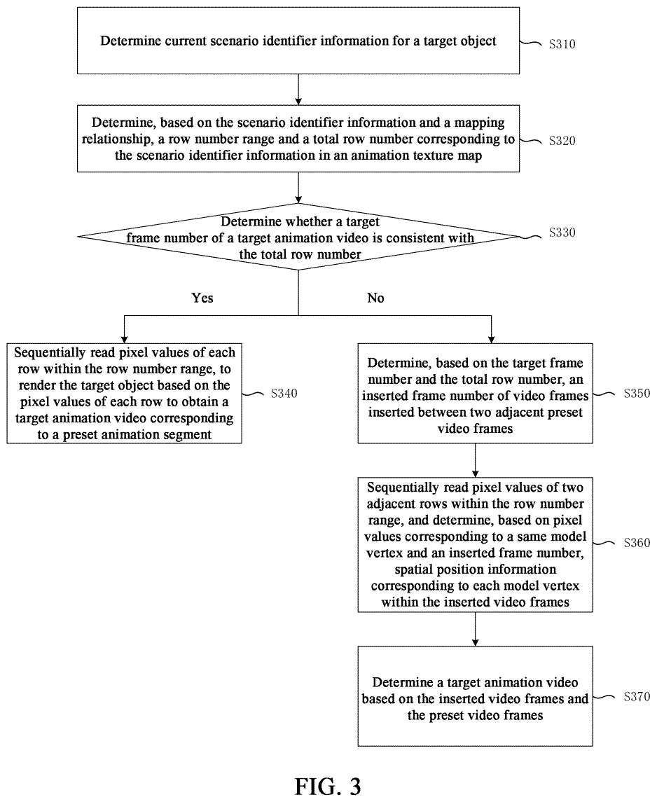

FIG. 3 is a schematic flowchart of another video generation method according to an embodiment of the present disclosure. Based on the above embodiment, when generating the target animation video corresponding to the target object, whether a target frame number is consistent with a total row number of the corresponding row number range within the animation image may be determined, and therefore the target animation video corresponding to the target object may be generated based on a consistency determination result. For a specific implementation, reference may be made to the technical solution of this embodiment. Technical terms that are the same with or corresponding to those in the above embodiment are not repeated herein.

As shown in FIG. 3, the method includes the following steps:
S310: Determine current scenario identifying information for a target object.
S320: Determine, based on the scenario identifying information and a mapping relationship, a row number range and a total row number corresponding to the scenario identifying information in an animation image.

In this embodiment, after determining the current scenario identifying information for each target object, the row number range and the total row number corresponding to each scenario identifying information in the animation image may be determined based on the mapping relationship between the scenario identifying information and the row number range within the animation image. The row number range may be used to represent a frame number range of preset video frames corresponding to a preset animation segment. The total row number may be used to represent the sum of preset video frames corresponding to the preset animation segment.

In practical applications, after determining the scenario identifying information, the pre-established mapping relationship between the scenario identifying information and the row number range within the animation image may be acquired, and further, the row number range and the total row number corresponding to the scenario identifying information in the animation image corresponding to the corresponding target object may be determined according to the current scenario identifying information for each target object.
S330: Determine whether a target frame number of a target animation video is consistent with the total row number, if yes, perform S340, and if the target frame number of the target animation video is not consistent with the total row number, perform S350 to S370.

In this embodiment, the target frame number may be the total number of animation video frames included in the target animation video.

The corresponding method for generating the target animation video when the target frame number is equal to the total row number is different from the method for generating the target animation video when the target frame number is unequal to the total row number.

When determining the total row number of each scenario identifying information in the animation image, the target frame number of the target animation video corresponding to each target object may be determined, and whether each target frame number is consistent with the corresponding total row number is determined so as to determine, based on the consistency determination result, the target animation video corresponding to each target object.

When there are a plurality of target objects in the displaying interface, the target frame number of the target animation videos corresponding to the plurality of target objects may be the same or different, which is not specifically limited in this embodiment of the present disclosure.
S340: Sequentially read pixel values of each row within the row number range, to render the target object based on the pixel values of each row to obtain a target animation video corresponding to the preset animation segment.

In this embodiment, when the target frame number is consistent with the total row number, it may be determined that the target frame number of the target animation video is consistent with a preset video frame number of the preset animation segment. Since the pixel values of each row within the animation image correspond to displaying positions of one model vertex within the corresponding preset video frame, the pixel values of each row within the corresponding row number range may be sequentially read, and for the pixel values of each row within the row number range, the plurality of pixel values may be converted into displaying positions of the plurality of model vertices within the corresponding preset video frames through the linear mapping method, to render the target object based on the displaying positions of the plurality of model vertices to obtain the target animation video corresponding to the preset animation segment.

The settings are advantageous as they can rapidly generate the target animation video on the premise of reducing the data storage amount, save the time in generating the target animation video, and thus the user experience is improved.
S350: Determine, based on the target frame number and the total row number, an inserted frame number of video frames inserted between two adjacent preset video frames.

In this embodiment, when the target frame number is not consistent with the total row number, that is, the target frame number is greater than the total row number, it may be determined that the target frame number of the target animation video is greater than the preset video frame number of the preset animation segment, and in this case, to make the preset video frame number of the preset animation segment consistent with the target frame number, a frame insertion method may be used to process the preset animation segment. The inserted video frames may be video frames newly added between the two adjacent preset video frames.

In practical applications, a difference between the target frame number and the total row number may be first determined to obtain a video frame number difference between the preset animation segment and the target animation video. Then, based on the video frame number difference, a total inserted frame number of the video frames to be inserted into the preset animation segment is determined. Finally, based on the total inserted frame number, the inserted frame number of the video frames to be inserted between the two adjacent preset video frames may be determined.

When determining the inserted frame number of the video frames inserted between the two adjacent preset video frames, the total inserted frame number may be evenly allocated between a plurality of pairs of adjacent preset video frames, or the total inserted frame number may be randomly allocated between the plurality of pairs of adjacent preset video frames. This embodiment of the present disclosure does not impose specific limitations on this.
S360: Sequentially read pixel values of two adjacent rows within the row number range, and determine, based on pixel values corresponding to a same model vertex and an inserted frame number, spatial position information corresponding to each model vertex within the inserted video frames.

In practical applications, the pixel values of the two adjacent rows within the row number range may be sequentially read so as to determine the pixel values corresponding to the same model vertex within the two adjacent rows. Then, the pixel values of the same model vertex in the inserted video frames are determined through a linear interpolation method based on these pixel values and the inserted frame number of the video frames to be inserted into the current two adjacent rows. Further, each pixel value is converted into the spatial position information through the linear mapping method, thereby obtaining the spatial position information corresponding to each model vertex in the inserted video frames.

When determining the spatial position information corresponding to each model vertex in the inserted video frames, the spatial position information of each model vertex in the preset video frames may also be determined based on the pixel values of each row within the row number range.
S370: Determine a target animation video based on the inserted video frames and the preset video frames.

In practical applications, after determining the spatial position information of each model vertex in the inserted video frames and the preset video frames, the target object may be rendered based on the spatial position information to obtain the target animation video corresponding to the target object.

The settings are advantageous as the problem that the frame number of the target animation video is unequal to the frame number of the preset animation segment can be solved, and pixel information of the inserted video frames is determined based on pixel information of two adjacent frames, thereby obtaining accurate image information and then improving the displaying effect of the target animation video.

According to the technical solution of this embodiment of the present disclosure, by determining the current scenario identifying information for the target object, then determining the row number range and the total row number corresponding to the scenario identifying information in the animation image based on the scenario identifying information and the mapping relationship, further determining whether the target frame number is consistent with the total row number, and determining the corresponding target animation video generation method based on the consistency determination result, the target animation video corresponding to the target object is finally obtained, thereby achieving the effect that the target animation video is closer to the preset animation segment, and enhancing diversity of the target animation video generation method, and therefore the target animation video corresponding to the target object can be rapidly obtained in different cases.

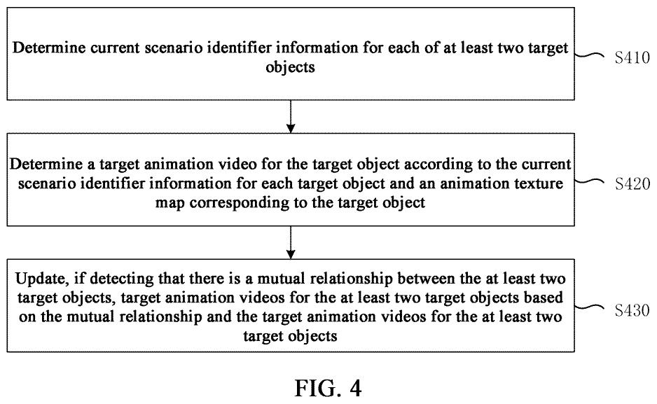

FIG. 4 is a schematic flowchart of another video generation method according to an embodiment of the present disclosure. Based on the above embodiment, for at least two target objects with a mutual relationship, target animation videos for the at least two target objects may also be updated based on the mutual relationship. For a specific implementation, reference may be made to the technical solution of this embodiment. Technical terms that are the same with or corresponding to those in the above embodiment are not repeated herein.

As shown in FIG. 4, the method includes the following steps:
S410: Determine current scenario identifying information for each of at least two target objects.
S420: Determine a target animation video for the target object according to the current scenario identifying information for each target object and an animation image corresponding to the target object.
S430: Update, if detecting that there is a mutual relationship between the at least two target objects, the target animation videos for the at least two target objects based on the mutual relationship and the target animation videos for the at least two target objects.

In this embodiment, the mutual relationship may be understood as a corresponding relationship when the at least two target objects interact with each other. Optionally, the mutual relationship may include a collaborative relationship or a mutually exclusive relationship. The collaborative relationship may be a collaborative relationship between the at least two target objects, and based on the collaborative relationship, corresponding actions are performed. The mutually exclusive relationship may be a corresponding relationship when the at least two target objects perform an action with a mutually exclusive effect at the same timestamp. Exemplarily, the collaborative relationship may indicate that when one target object is lifting a heavy object, the other target object helps the target object lift the heavy object together; and the mutually exclusive relationship may indicate that when two target objects collide while running, the two target objects are respectively moved to different tracks, and therefore the two target objects no longer collide.

In practical applications, when there are a plurality of target objects in the displaying interface and it is detected that there is the mutual relationship between at least two target objects, to present the mutual relationship in the displaying interface in an animation video manner, the target animation videos for the at least two target objects with the mutual relationship may be updated, such that the updated target animation videos continue to be played in the displaying interface.

Optionally, the step of updating the target animation videos for the at least two target objects based on the mutual relationship and the target animation videos for the at least two target objects includes: determining a preset animation segment to be updated based on a preset logical relationship if the mutual relationship is the collaborative relationship or the mutually exclusive relationship; and adjusting the target animation videos for the at least two target objects based on a row number range of the preset animation segment in the animation image.

In this embodiment, the logical relationship may be a preset basis for determining a next preset animation segment for the target animation video. Exemplarily, when the mutual relationship is the collaborative relationship, the logical relationship may indicate that there is the collaborative relationship between the at least two target objects; and when the mutual relationship is the mutually exclusive relationship, the logical relationship may indicate that there is no collision between the at least two target objects any more. In the practical application process, when detecting that there is the mutual relationship between the at least two target objects, the target animation video for each target object may be updated; and in addition, the target animation video may be updated based on the preset animation segment which is preset, for example, a next preset animation segment for a target object corresponding to a current moment may be used as the preset animation segment to be updated.

In practical applications, when detecting that there is the mutual relationship between the at least two target objects and the mutual relationship is the collaborative relationship or the mutually exclusive relationship, the preset logical relationship may be invoked, and therefore the preset animation segment to be updated for each target object is determined based on the logical relationship when there is the collaborative relationship, or the preset animation segment to be updated for each target object is determined based on the logical relationship when there is the mutually exclusive relationship. Further, the row number range of the preset animation segment to be updated for each target object in the corresponding animation image is determined based on the preset animation segment to be updated for each target object, and pixel values of each row within the row number range are sequentially read, thereby rendering the corresponding target object based on the pixel values of each row, and making the adjusted target animation video correspond to the corresponding preset animation segment to be updated. Exemplarily, if target animation videos corresponding to the two target objects are running animation videos and there is the mutually exclusive relationship between the two target objects, for example, when there is a collision on the same track, for example, the two target objects may collide on a track 2, preset animation segments to be updated for the two target objects may be determined as animation segments for switching the track to continue running. In this case, the target animation video for one of the two target objects may be switched to a track 1 to continue running, and the target animation video for the other target object may be switched to the track 2 to continue running. The settings are advantageous as the target animation videos may be updated for the target objects with the mutual relationship, such that the updated target animation videos more conform to the preset logical relationship, thereby making the target animation videos corresponding to the plurality of target objects reach an effect of being closer to a real world.

According to the technical solution of this embodiment of the present disclosure, by determining the current scenario identifying information for the at least one target object, then determining the target animation video for the at least one target object according to the scenario identifying information and the animation image corresponding to the at least one target object, further updating the target animation videos for the at least two target objects based on the mutual relationship and the target animation videos for the at least two target objects if the mutual relationship is detected between the at least two target objects, the target animation videos can be rapidly updated on the premise of reducing the data storage amount, thereby making the updated target animation videos closer to the real world, and improving the displaying effect of the target animation videos.

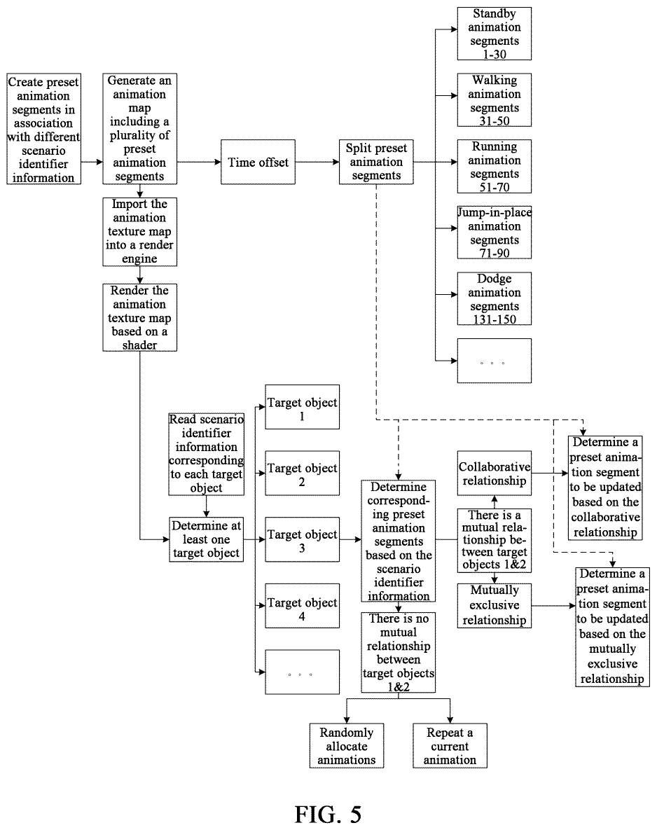

Exemplarily, the target animation video generation process may be described in combination with a flowchart shown in FIG. 5. Firstly, create preset animation segments in association with different scenario identifying information. Secondly, generate an animation image including a plurality of preset animation segments. Thirdly, import the animation image into a render engine, and meanwhile split, based on a frame offset method, the plurality of preset animation segments in the animation image, where the plurality of preset animation segments may include standby animation segments (rows 1 to 30), slow walk animation segments (rows 31 to 50), running animation segments (rows 51 to 70), jump-in-place animation segments (rows 71 to 90), and dodge animation segments (rows 91 to 130). Fourthly, render the animation image based on a shader. Fifthly, determine at least one target object, which may include a target object 1, a target object 2, a target object 3, a target object 4, etc., and meanwhile read scenario identifying information of each target object. Sixthly, determine a target animation video corresponding to each target object based on the scenario identifying information. Seventhly, if there is no mutual relationship between the target object 1 and the target object 2, repeatedly play the target animation video, or randomly determine a next preset animation segment for the target animation video so as to update the target animation video. Eighthly, if there is the mutual relationship between the target object 1 and the target object 2, determine whether the mutual relationship is the collaborative relationship or the mutually exclusive relationship. Ninthly, if the mutual relationship is the collaborative relationship, determine a preset animation segment to be updated according to the collaborative relationship so as to update the target animation video based on the preset animation segment. Tenthly, if the mutual relationship is the mutually exclusive relationship, determine a preset animation segment to be updated according to the mutually exclusive relationship so as to update the target animation video based on the preset animation segment.

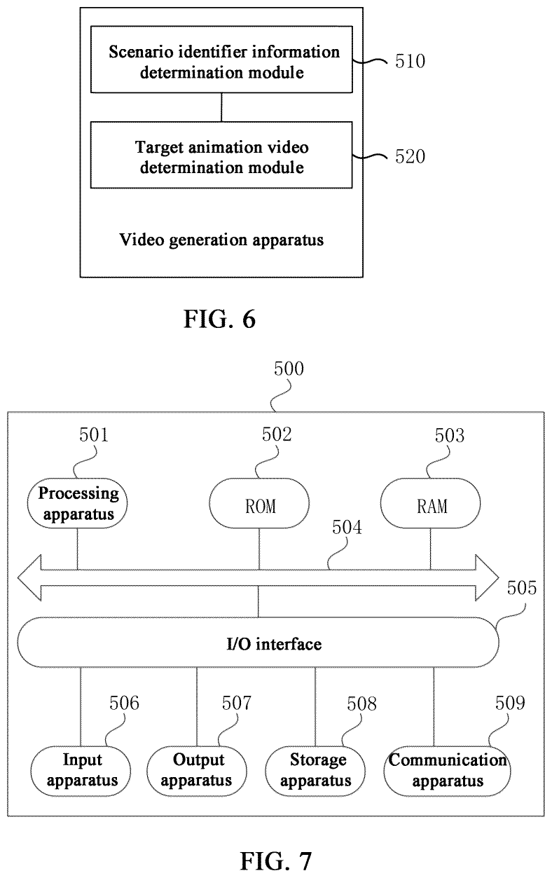

FIG. 6 is schematic diagram of a structure of a video generation apparatus according to an embodiment of the present disclosure. As shown in FIG. 6, the apparatus includes: a scenario identifying information determination module 510 and a target animation video determination module 520.

The scenario identifying information determination module 510 is configured to determine current scenario identifying information for a target object; and the target animation video determination module 520 is configured to determine a target animation video for the target object according to the scenario identifying information and an animation image corresponding to the target object, where the animation image includes displaying position information of at least a portion of mesh models of a target model corresponding to the target object being displayed in preset video frames, and the target animation video includes the preset video frames.

Based on the above technical solution, the scenario identifying information determination module 510 includes a current position information determination unit and a scenario identifying information determination unit.

The current position information determination unit is configured to determine current position information of the target object; and the scenario identifying information determination unit is configured to determine, according to the current position information and preset spatial range information corresponding to at least one sub-scenario, a target sub-scenario corresponding to the current position information and scenario identifying information corresponding to the target sub-scenario.

Based on the above various technical solutions, the apparatus further includes: a target model creation module and an animation image generation module.

The target model creation module is configured to create a target model corresponding to the target object, where the target model is composed of at least one mesh model; and the animation image generation module is configured to create preset animation segments corresponding to the target object in association with different scenario identifying information, and generate an animation image corresponding to the target object based on the preset animation segments corresponding to the target object in the different scenario identifying information and the at least one mesh model of the target model, where each of the preset animation segments corresponding to the target object in the different scenario identifying information is composed of a plurality of video frames, and the plurality of video frames are used as the preset video frames.

Based on the above various technical solutions, the animation image generation module includes: a pixel value determination submodule and an animation image updating submodule.

The pixel value determination submodule is configured to acquire, for each of the preset animation segments corresponding to the target object in the different scenario identifying information, a first preset video frame in the preset animation segment, determine spatial position information of each of at least three model vertices on each mesh model in the first preset video frame, and determine pixel values of nth-row pixel points in the animation image based on the spatial position information, where n corresponds to a frame number of the first preset video frame in all the preset animation segments; and the animation image updating submodule is configured to acquire a next preset video frame for the first preset video frame and repeatedly perform, until all preset video frames in the preset animation segment are traversed, the operation of determining pixel values corresponding to spatial position information of each of at least three model vertices on each mesh model, and update an (n+1)th-row of the animation image with the determined pixel values, where each column of the animation image corresponds to one model vertex in the at least one mesh model.

Based on the above technical solution, the pixel value determination submodule includes: a pixel value determination unit and a pixel value assignment unit.

The pixel value determination unit is configured to determine a pixel value corresponding to spatial position information of each model vertex; and the pixel value assignment unit is configured to assign, according to preset model vertices corresponding to each column of the animation image, the pixel value corresponding to the spatial position information of each model vertex to an nth-row pixel point corresponding to each model vertex.

Based on the above technical solution, each column of the animation image represents a model vertex of the at least one mesh model, each row represents a preset video frame within preset animation segments corresponding to the target object in the different scenario identifying information, and a pixel value of each pixel point in the animation image represents a displaying position of one model vertex in one preset video frame.

Based on the above technical solution, the apparatus further includes: a mapping relationship establishment module.

The mapping relationship establishment module is configured to establish, according to a row number range in the animation image corresponding to each of the preset animation segments corresponding to the target object in the different scenario identifying information, a mapping relationship between each of the different scenario identifying information and the row number range corresponding to each scenario identifying information so as to determine a target animation video for the target object based on the mapping relationship.

Based on above technical solution, the target animation video determination module 520 is configured to determine the target animation video based on the scenario identifying information, the animation image corresponding to the target object, and video parameters corresponding to the target animation video.

Based on above technical solution, the video parameters include a target frame number of the target animation video, and the target animation video determination module 520 includes: a row number range determination unit and a target animation video determination unit.

The row number range determination unit is configured to determine, based on the scenario identifying information and the mapping relationship, a row number range and a total row number corresponding to the scenario identifying information in the animation image;

The target animation video determination unit is configured to sequentially read pixel values of each row within the row number range in response to determining that the target frame number is equal to the total row number, to render the target object based on the pixel values of each row to obtain a target animation video corresponding to the preset animation segment corresponding to the scenario identifying information.

Based on the above technical solution, the apparatus further includes: an inserted frame number determination module, a spatial position information determination module, and a target animation video determination module.

The inserted frame number determination module is configured to determine, based on the target frame number and the total row number, an inserted frame number of video frames inserted between two adjacent preset video frames in response to determining that the target frame number is greater than the total row number; the spatial position information determination module is configured to sequentially read pixel values of two adjacent rows within the row number range, and determine, based on pixel values corresponding to the same model vertex and the inserted frame number, spatial position information corresponding to each model vertex within the inserted video frames; and the target animation video determination module is configured to determine the target animation video based on the inserted video frames and the preset video frames.

Based on the above technical solution, there are at least two target objects, and the apparatus further includes: a target animation video update module.

The target animation video update module is configured to update, in the case of detecting that there is a mutual relationship between at least two target objects, the target animation videos for the at least two target objects based on the mutual relationship and the target animation videos for the at least two target objects.

Based on above technical solution, the mutual relationship includes a collaborative relationship or a mutually exclusive relationship. The target animation video update module includes: a preset animation segment determination unit and a target animation video adjustment unit.

The preset animation segment determination unit is configured to determine, based on a preset logical relationship, a preset animation segment to be updated for each target object if the mutual relationship is the collaborative relationship or the mutually exclusive relationship; and the target animation video adjustment unit is configured to adjust the target animation videos for the at least two target objects based on a row number range of the preset animation segment for each target object in the animation image.

Based on the above technical solution, the apparatus further includes: a target animation video playback module.

The target animation video playback module is configured to play, according to video playback parameters corresponding to a target animation video, the target animation video.

Based on the above technical solution, the video playback parameters include at least one of loop playback, single playback, a playback duration, and a next preset animation segment for the target animation video.

According to the technical solution of this embodiment of the present disclosure, by determining the current scenario identifying information for the at least one target object and further determining the target animation video for the at least one target object according to the scenario identifying information and the animation image corresponding to the at least one target object, the problem that when the target animation video is rendered under the condition of the limited performance of a terminal device, the corresponding target animation video cannot be rendered is solved. The effect of rapidly generating the target animation video corresponding to each target object is achieved on the premise of reducing the data storage amount. Moreover, by making the target animation video correspond to the corresponding scenario identifying information, different target animation videos may be simultaneously rendered in the same displaying interface, thereby achieving a clustered animation effect and improving use experience of the user.

The video generation apparatus provided in this embodiment of the present disclosure may perform the video generation method provided in any embodiment of the present disclosure, and has the corresponding functional modules and effects for performing the method.

The plurality of units and modules included in the above apparatus are only divided according to functional logics, but are not limited to the above division, as long as the corresponding functions can be achieved; and in addition, the names of the plurality of units and modules are only for the convenience of distinguishing each other, and are not intended to limit the scope of protection of the embodiments of the present disclosure.

FIG. 7 is a schematic diagram of a structure of an electronic device according to an embodiment of the present disclosure. Referring to FIG. 7 as below, FIG. 7 illustrates a schematic diagram of a structure of an electronic device (e.g., a terminal device or a server in FIG. 7) 500 suitable for implementing an embodiment of the present disclosure. The terminal device in this embodiment of the present disclosure may include, but is not limited to, mobile terminals such as a mobile phone, a notebook computer, a digital radio receiver, a personal digital assistant (PDA), a portable Android device (PAD), a portable media player (PMP), a vehicle-mounted terminal (e.g., a vehicle navigation terminal), and fixed terminals such as a digital television (TV) and a desk computer. The electronic device shown in FIG. 7 is merely an example, and should not impose any limitation on the function and scope of use of the embodiments of the present disclosure.

As shown in FIG. 7, the electronic device 500 may include a processing apparatus (e.g., a central processing unit and a graphics processing unit) 501, which may perform various appropriate actions and processing according to a program stored on a read-only memory (ROM) 502 or a program loaded from a storage apparatus 508 into a random access memory (RAM) 503. The RAM 503 further stores various programs and data required for the operation of the electronic device 500. The processing apparatus 501, the ROM 502, and the RAM 503 are connected to one another through a bus 504. An input/output (I/O) interface 505 is also connected to the bus 504.

Typically, the following apparatuses may be connected to the I/O interface 505: an input apparatus 506, including, for example, a touchscreen, a touchpad, a keyboard, a mouse, a camera, a microphone, an accelerometer, and a gyroscope; an output apparatus 507, including, for example, a liquid crystal display (LCD), a speaker, and a vibrator; the storage apparatus 508, including, for example, a magnetic tape and a hard drive; and a communication apparatus 509. The communication apparatus 509 may allow the electronic device 500 to be in wireless or wired communication with other devices for data exchange. Although FIG. 7 illustrates the electronic device 500 with various apparatuses, it should be understood that it is not necessary to implement or have all the shown apparatuses. It may be an alternative to implement or have more or fewer apparatuses.

According to this embodiment of the present disclosure, the above process described with reference to the flowchart may be implemented as a computer software program. For example, an embodiment of the present disclosure includes a computer program product, which includes a computer program carried on a non-transitory computer-readable medium, where the computer program includes program code used to perform the method shown in the flowchart. In this embodiment, the computer program may be downloaded and installed from the network through the communication apparatus 509, or installed from the storage apparatus 508, or installed from the ROM 502. The computer program, when executed by the processing apparatus 501, performs the above functions limited in the method in this embodiment of the present disclosure.

The names of messages or information exchanged between a plurality of apparatuses in the implementations of the present disclosure are used for illustrative purposes only, and are not used to limit the scope of these messages or information.

The electronic device provided in this embodiment of the present disclosure and the video determining method provided in the above embodiment belong to the same inventive concept, and for technical details not described in detail in this embodiment, reference may be made to the above embodiment. This embodiment and the above embodiment have the same effects.

An embodiment of the present disclosure provides a computer storage medium, storing a computer program. The program, when executed by a processor, implements the video generation method provided in the above embodiment.

The computer-readable medium in the present disclosure may be a computer-readable signal medium, or a computer-readable storage medium, or any combination of the two. The computer-readable storage medium may be, for example, but is not limited to, electric, magnetic, optical, electromagnetic, infrared, or semiconductor systems, apparatuses, or devices, or any combination of the above. More specific examples of the computer-readable storage medium may include, but are not limited to: an electrical connection with one or more wires, a portable computer disk, a hard drive, a RAM, a ROM, an erasable programmable read-only memory (EPROM) or a flash memory, optical fiber, a portable compact disc read-only memory (CD-ROM), an optical storage device, a magnetic storage device, or any suitable combination of the above. In the present disclosure, the computer-readable storage medium may be any tangible medium including or storing a program, and the program may be for use by or for use in combination with an instruction execution system, apparatus, or device. However, in the present disclosure, the computer-readable signal medium may include a data signal propagated in a baseband or as a part of a carrier, where the data signal carries computer-readable program code. The propagated data signal may take various forms, including but not limited to an electromagnetic signal, an optical signal, or any suitable combination of the above. The computer-readable signal medium may also be any computer-readable medium other than the computer-readable storage medium. The computer-readable signal medium may send, propagate, or transmit a program for use by or for use in combination with the instruction execution system, apparatus, or device. The program code included in the computer-readable medium may be transmitted by any suitable medium including but not limited to a wire, an optical cable, radio frequency (RF), etc., or any suitable combination of the above.

In some implementations, a client and a server may communicate using any currently known or future-developed network protocols such as a hypertext transfer protocol (HTTP), and may also be interconnected with digital data communication in any form or medium (e.g., a communication network). Examples of the communication network include a local area network (LAN), a wide area network (WAN), Internet work (e.g., Internet), a peer-to-peer network (e.g., an ad hoc peer-to-peer network), and any currently known or future-developed networks.

The above computer-readable medium may be included in the above electronic device; or may also separately exist without being assembled in the electronic device.

The above computer-readable medium carries one or more programs. The above one or more programs, when executed by the electronic device, cause the electronic device to: determine current scenario identifying information for a target object; and determine a target animation video for the target object according to the scenario identifying information and an animation image corresponding to the target object, where the animation image includes displaying position information of at least a portion of mesh models of a target model corresponding to the target object being displayed in preset video frames, and the target animation video includes the preset video frames.

Computer program code for performing operations of the present disclosure may be written in one or more programming languages or a combination thereof, where the above programming languages include, but are not limited to, object-oriented programming languages, such as Java, Smalltalk, and C++, and further include conventional procedural programming languages, such as “C” language or similar programming languages. The program code may be executed entirely on a user computer, partly on the user computer, as a stand-alone software package, partly on the user computer and partly on a remote computer, or entirely on the remote computer or the server. In the case of involving the remote computer, the remote computer may be connected to the user computer through any type of network, including a LAN or WAN, or may be connected to an external computer (e.g., utilizing an Internet service provider for Internet connectivity).

The flowcharts and the block diagrams in the accompanying drawings illustrate the possibly implemented system architecture, functions, and operations of the system, the method, and the computer program product according to the various embodiments of the present disclosure. In this regard, each block in the flowcharts or the block diagrams may represent a module, a program segment, or a part of code, and the module, the program segment, or the part of code contains one or more executable instructions for implementing specified logical functions. It should also be noted that in some alternative implementations, the functions marked in the blocks may also occur in an order different from that marked in the accompanying drawings. For example, two blocks shown in succession may actually be performed substantially in parallel, or may sometimes be performed in a reverse order, depending on the functions involved. It should also be noted that each block in the block diagrams and/or the flowcharts, and a combination of the blocks in the block diagrams and/or the flowcharts may be implemented by using a dedicated hardware-based system that performs specified functions or operations, or may be implemented by using a combination of dedicated hardware and computer instructions.

The units and the modules described in the embodiments of the present disclosure may be implemented through software or hardware. The names of the units and the modules do not limit the units and the modules. For example, the scenario identifying information determination module may also be described as “a module for determining current scenario identifying information for a target object”.

Herein, the functions described above may be at least partially executed by one or more hardware logic components. For example, exemplary hardware logic components that can be used include, but are not limited to: a field programmable gate array (FPGA), an application specific integrated circuit (ASIC), application specific standard parts (ASSPs), a system on chip (SOC), a complex programmable logic device (CPLD), etc.

In the context of the present disclosure, a machine-readable medium may be a tangible medium that may contain or store a program used by or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include: an electrical connection based on one or more wires, a portable computer disk, a hard drive, a RAM, a ROM, an EPROM or a flash memory, an optical fiber, a portable CD-ROM, an optical storage device, a magnetic storage device, or any suitable combination of the above content.

According to one or more embodiments of the present disclosure, [Example 1] provides a video generation method, including: determining current scenario identifying information for a target object; and determining a target animation video for the target object according to the scenario identifying information and an animation image corresponding to the target object, where the animation image includes displaying position information of at least a portion of mesh models of a target model corresponding to the target object being displayed in preset video frames, and the target animation video includes the preset video frames.

According to one or more embodiments of the present disclosure, [Example 2] provides a video generation method, further including: optionally, determining current scenario identifying information for the target object including: determining current position information of the target object; and determining, according to the current position information and preset spatial range information corresponding to sub-scenarios, a target sub-scenario corresponding to the current position information and scenario identifying information corresponding to the target sub-scenario.

According to one or more embodiments of the present disclosure, [Example 3] provides a video generation method, further including: optionally, creating a target model corresponding to the target object, where the target model is composed of at least one mesh model; creating preset animation segments corresponding to the target object in association with different scenario identifying information, and generating an animation image corresponding to the target object based on the preset animation segments corresponding to the target object in the different scenario identifying information and the at least one mesh model of the target model, where each of the preset animation segments corresponding to the target object in the different scenario identifying information is composed of a plurality of video frames, and the plurality of video frames are used as the preset video frames.

According to one or more embodiments of the present disclosure, [Example 4] provides a video generation method, further including: optionally, generating the animation image corresponding to the target object based on the preset animation segments corresponding to the target object in the different scenario identifying information and the at least one mesh model of the target model including: acquiring, for each of the preset animation segments corresponding to the target object in the different scenario identifying information, a first preset video frame in the preset animation segment, determining spatial position information of each of at least three model vertices on each mesh model in the first preset video frame, and determining pixel values of nth-row pixel points in the animation image based on the spatial position information, where n corresponds to a frame number of the first preset video frame in all the preset animation segments; and acquiring a next preset video frame for the first preset video frame and repeatedly performing, until all preset video frames in the preset animation segment are traversed, the operation of determining pixel values corresponding to spatial position information of each of at least three model vertices on each mesh model, and updating an (n+1)th row with the determined pixel values of the animation image, where each column of the animation image corresponds to one model vertex in the at least one mesh model.

According to one or more embodiments of the present disclosure, [Example 5] provides a video generation method, further including: optionally, determining pixel values of nth-row pixel points in the animation image based on the spatial position information including: determining a pixel value corresponding to spatial position information of each model vertex; and assigning, according to preset model vertices corresponding to each column of the animation image, the pixel value corresponding to the spatial position information of each model vertex to an nth row pixel point corresponding to each model vertex.

According to one or more embodiments of the present disclosure, [Example 6] provides a video generation method, further including: optionally, each column of the animation image representing a model vertex of the at least one mesh model, each row representing a preset video frame within preset animation segments corresponding to the target object in the different scenario identifying information, and a pixel value of each pixel point in the animation image representing a displaying position of one model vertex in one preset video frame.

According to one or more embodiments of the present disclosure, [Example 7] provides a video generation method, further including: optionally, establishing, according to a row number range in the animation image corresponding to each of the preset animation segments corresponding to the target object in the different scenario identifying information, a mapping relationship between each of the different scenario identifying information and the row number range corresponding to each scenario identifying information so as to determine a target animation video for the target object based on the mapping relationship.

According to one or more embodiments of the present disclosure, [Example 8] provides a video generation method, further including: optionally, determining the target animation video for the target object according to the scenario identifying information and the animation image corresponding to the target object including: determining the target animation video according to the scenario identifying information, the animation image corresponding to the target object, and video parameters corresponding to the target animation video.

According to one or more embodiments of the present disclosure, [Example 9] provides a video generation method, where the video parameters include a target frame number of a target animation video, and the method further includes: optionally, determining the target animation video according to the scenario identifying information, the animation image corresponding to the target object, and the video parameters corresponding to the target animation video including: determining, based on the scenario identifying information and a mapping relationship, a row number range and a total row number corresponding to the scenario identifying information in the animation image; and sequentially reading pixel values of each row within the row number range in response to determining that the target frame number is equal to the total row number, to render the target object based on the pixel values of each row to obtain the target animation video corresponding to the preset animation segment corresponding to the scenario identifying information.

According to one or more embodiments of the present disclosure, [Example 10] provides a video generation method, further including: determining, based on the target frame number and the total row number, an inserted frame number of video frames to be inserted between two adjacent preset video frames in response to determining that the target frame number is greater than the total row number; sequentially reading pixel values of two adjacent rows within the row number range, and determining, based on pixel values corresponding to the same model vertex and the inserted frame number, spatial position information corresponding to each model vertex within the inserted video frames; and determining the target animation video based on the inserted video frames and the preset video frames.

According to one or more embodiments of the present disclosure, [Example 11] provides a video generation method, where there are at least two target objects, and the method further includes: optionally, updating, in the case of detecting that there is a mutual relationship between at least two target objects, target animation videos for the at least two target objects based on the mutual relationship and the target animation videos for the at least two target objects.

According to one or more embodiments of the present disclosure, [Example 12] provides a video generation method, where the mutual relationship includes a collaborative relationship or a mutually exclusive relationship, and the method further includes: optionally, determining, based on a preset logical relationship, a preset animation segment to be updated for each target object if the mutual relationship is the collaborative relationship or the mutually exclusive relationship; and adjusting the target animation videos for the at least two target objects based on a row number range of the preset animation segment for each target object in the animation image.

According to one or more embodiments of the present disclosure, [Example 13] provides a video generation method, further including: optionally, playing, according to video playback parameters corresponding to a target animation video, the target animation video.

According to one or more embodiments of the present disclosure, [Example 14] provides a video generation method, further including: optionally, the video playback parameters including at least one of loop playback, single playback, a playback duration, and a next preset animation segment for the target animation video.

According to one or more embodiments of the present disclosure, [Example 15] provides a video generation apparatus, including: a scenario identifying information determination module, configured to determine current scenario identifying information for a target object; and a target animation video determination module, configured to determine a target animation video for the target object according to the scenario identifying information and an animation image corresponding to the target object, where the animation image includes displaying position information of at least a portion of mesh models of a target model corresponding to the target object being displayed in preset video frames, and the target animation video includes the preset video frames.

Although the plurality of operations is described in a particular order, it should not be understood as requiring these operations to be performed in the shown particular order or in a sequential order. In certain environments, multitasking and parallel processing may be advantageous. Similarly, although specific implementation details are included in the above discussion, these specific implementation details should not be interpreted as limitations on the scope of the present disclosure. Some features described in the context of separate embodiments may also be implemented in combination in a single embodiment. Various features described in the context of a single embodiment may also be implemented in a plurality of embodiments separately or in any suitable sub-combination.

Although the subject matter has been described in a language specific to structural features and/or logic actions of the method, it should be understood that the subject matter defined in the appended claims is not necessarily limited to the specific features or actions described above. The specific features and the actions described above are merely example forms for implementing the claims.

1. A video generation method, comprising:
determining current scenario identifying information for a target object; and
determining a target animation video for the target object according to the scenario identifying information and an animation image corresponding to the target object,
wherein the animation image comprises displaying position information of at least a portion of mesh models of a target model corresponding to the target object being displayed in preset video frames, and the target animation video comprises the preset video frames.

2. The method according to claim 1, wherein the determining the current scenario identifying information for the target object comprises:
determining current position information of the target object; and
determining, according to the current position information and preset spatial range information corresponding to at least one sub-scenario, a target sub-scenario corresponding to the current position information and scenario identifying information corresponding to the target sub-scenario.

3. The method according to claim 1, further comprising:
creating a target model corresponding to the target object, wherein the target model is composed of at least one mesh model; and
creating preset animation segments corresponding to the target object in association with different scenario identifying information, and generating an animation image corresponding to the target object based on the preset animation segments corresponding to the target object in association with the different scenario identifying information and the at least one mesh model of the target model,
wherein each of the preset animation segments corresponding to the target object in association with different scenario identifying information is composed of a plurality of video frames, and the plurality of video frames are used as the preset video frames.

4. The method according to claim 3, wherein the generating the animation image corresponding to the target object based on the preset animation segments corresponding to the target object in association with different scenario identifying information and the at least one mesh model of the target model comprises:
acquiring, for each of the preset animation segments corresponding to the target object in association with different scenario identifying information, a first preset video frame in the preset animation segment, determining spatial position information of each of at least three model vertices on each mesh model in the first preset video frame, and determining pixel values of nth-row pixel points in the animation image based on the spatial position information, wherein n corresponds to a frame number of the first preset video frame in all the preset animation segments; and
acquiring a next preset video frame of the first preset video frame and repeatedly performing, until all preset video frames in the preset animation segment are traversed, an operation of determining pixel values corresponding to spatial position information of each of at least three model vertices on each mesh model, and updating an (n+1)th-row of the animation image with the determined pixel values,
wherein each column of the animation image corresponds to one model vertex in the at least one mesh model.

5. The method according to claim 4, wherein the determining the pixel values of nth-row pixel points in the animation image based on the spatial position information comprises:
determining a pixel value corresponding to spatial position information of each model vertex; and
assigning, according to preset model vertices corresponding to each column of the animation image, the pixel value corresponding to the spatial position information of each model vertex to an nth-row pixel point corresponding to each model vertex.

6. The method according to claim 3, wherein each column of the animation image represents a model vertex of the at least one mesh model, each row represents a preset video frame within preset animation segments corresponding to the target object in association with different scenario identifying information, and a pixel value of each pixel point in the animation image represents a displaying position of one model vertex in one preset video frame.

7. The method according to claim 3, further comprising:
establishing, according to a row number range in the animation image corresponding to each of the preset animation segments corresponding to the target object in association with different scenario identifying information, a mapping relationship between each of the different scenario identifying information and the row number range corresponding to each scenario identifying information, to determine a target animation video for the target object based on the mapping relationship.

8. The method according to claim 1, wherein the determining the target animation video for the target object according to the scenario identifying information and an animation image corresponding to the target object comprises:
determining the target animation video according to the scenario identifying information, the animation image corresponding to the target object, and video parameters corresponding to the target animation video.

9. The method according to claim 8, wherein the video parameters comprise a target frame number of the target animation video, and the determining the target animation video according to the scenario identifying information, the animation image corresponding to the target object, and video parameters corresponding to the target animation video comprises:
determining, based on the scenario identifying information and a mapping relationship, a row number range and a total row number corresponding to the scenario identifying information in the animation image; and
sequentially reading pixel values of each row within the row number range in response to determining that the target frame number is equal to the total row number, to render the target object based on the pixel values of each row and thus to obtain the target animation video corresponding to the preset animation segment corresponding to the scenario identifying information.

10. The method according to claim 9, further comprising:
determining, based on the target frame number and the total row number, an inserted frame number of video frames to be inserted between two adjacent preset video frames in response to determining that the target frame number is greater than the total row number;
sequentially reading pixel values of two adjacent rows within the row number range, and determining, based on pixel values corresponding to a same model vertex and the inserted frame number, spatial position information corresponding to each model vertex within the inserted video frames; and
determining the target animation video based on the inserted video frames and the preset video frames.

11. The method according to claim 1, wherein there are at least two target objects, and the method further comprises:
updating, in accordance with a detection that there is a mutual relationship between the at least two target objects, target animation videos for the at least two target objects based on the mutual relationship and the target animation videos for the at least two target objects.

12. The method according to claim 11, wherein the mutual relationship comprises a collaborative relationship or a mutually exclusive relationship; and
wherein the updating the target animation videos for the at least two target objects based on the mutual relationship and the target animation videos for the at least two target objects comprises:
determining, based on a preset logical relationship, a preset animation segment to be updated for each target object in accordance with a determination that the mutual relationship is the collaborative relationship or the mutually exclusive relationship; and
adjusting the target animation videos for the at least two target objects based on a row number range of the preset animation segment to be updated for each target object in the animation image.

13. The method according to claim 1, further comprising:
playing, according to video playback parameters corresponding to a target animation video, the target animation video.

14. The method according to claim 13, wherein the video playback parameters comprise at least one of loop playback, single playback, a playback duration, and a next preset animation segment for the target animation video.

15. (canceled)

16. An electronic device, comprising:
at least one processor; and
a storage, configured to store at least one program,
wherein the at least one program, when executed by the one or more processors, causes the at least one processor to:
determine current scenario identifying information for a target object; and
determine a target animation video for the target object according to the scenario identifying information and an animation image corresponding to the target object,
wherein the animation image comprises displaying position information of at least a portion of mesh models of a target model corresponding to the target object being displayed in preset video frames, and the target animation video comprises the preset video frames.

17. A non-transitory storage medium comprising computer-executable instructions, wherein the computer-executable instructions, when executed by a computer processor, cause the computer processor to:
determine current scenario identifying information for a target object; and
determine a target animation video for the target object according to the scenario identifying information and an animation image corresponding to the target object,
wherein the animation image comprises displaying position information of at least a portion of mesh models of a target model corresponding to the target object being displayed in preset video frames, and the target animation video comprises the preset video frames.

18. The electronic device according to claim 16, wherein the determining current scenario identifying information for the target object comprises:
determining current position information of the target object; and
determining, according to the current position information and preset spatial range information corresponding to at least one sub-scenario, a target sub-scenario corresponding to the current position information and scenario identifying information corresponding to the target sub-scenario.

19. The electronic device according to claim 16, wherein the at least one program, when executed by the one or more processors, further causes the at least one processor to:
create a target model corresponding to the target object, wherein the target model is composed of at least one mesh model; and
create preset animation segments corresponding to the target object in association with different scenario identifying information, and generating an animation image corresponding to the target object based on the preset animation segments corresponding to the target object in association with the different scenario identifying information and the at least one mesh model of the target model,
wherein each of the preset animation segments corresponding to the target object in association with different scenario identifying information is composed of a plurality of video frames, and the plurality of video frames are used as the preset video frames.

20. The electronic device according to claim 19, wherein the generating the animation image corresponding to the target object based on the preset animation segments corresponding to the target object in association with different scenario identifying information and the at least one mesh model of the target model comprises:
acquiring, for each of the preset animation segments corresponding to the target object in association with different scenario identifying information, a first preset video frame in the preset animation segment, determining spatial position information of each of at least three model vertices on each mesh model in the first preset video frame, and determining pixel values of nth-row pixel points in the animation image based on the spatial position information, wherein n corresponds to a frame number of the first preset video frame in all the preset animation segments; and
acquiring a next preset video frame of the first preset video frame and repeatedly performing, until all preset video frames in the preset animation segment are traversed, an operation of determining pixel values corresponding to spatial position information of each of at least three model vertices on each mesh model, and updating an (n+1)th-row of the animation image with the determined pixel values,
wherein each column of the animation image corresponds to one model vertex in the at least one mesh mode.

21. The electronic device according to claim 20, wherein the determining pixel values of nth-row pixel points in the animation image based on the spatial position information comprises:
determining a pixel value corresponding to spatial position information of each model vertex; and
assigning, according to preset model vertices corresponding to each column of the animation map, the pixel value corresponding to the spatial position information of each model vertex to an nth-row pixel point corresponding to each model vertex.
